(19) United States
(12) Patent Application Publication
(10) Pub. No.: US 2013/0023689 A1
(43) Pub. Date: Jan. 24, 2013

(54) PROCESS FOR THE BORYLATION OF ORGANOHALIDES

(71) Applicants: Joachim Schmidt-Leithoff, Pennsylvania (DE); Stefan Pichlmair, Pittsburgh, PA (US); Charles Bello, Tarentum, PA (US)

(72) Inventors: Joachim Schmidt-Leithoff, Pennsylvania (DE); Stefan Pichlmair, Pittsburgh, PA (US); Charles Bello, Tarentum, PA (US)

(73) Assignee: BASF SE, Ludwigshafen (DE)

(21) Appl. No.: 13/552,736

(22) Filed: Jul. 19, 2012

Related U.S. Application Data
(60) Provisional application No. 61/510,508, filed on Jul. 22, 2011.

(51) Int. Cl. C07F 5/04

(52) U.S. Cl. 558/288

(57) ABSTRACT

The present invention relates to a process for the borylation of organohalides.

### FIELD OF THE INVENTION

The present invention relates to a process for the borylation of organohalides.

### BACKGROUND OF THE INVENTION

In organic chemistry, numerous reactions for the formation of carbon-carbon bonds are known. In general, the term “cross-coupling” is understood to mean a catalyzed reaction, usually using a transition metal catalyst, between an organic electrophile and an organic nucleophile, for example an organometallic compound, to form a new carbon-carbon bond. The transition metalcatalyzed cross-coupling reaction between organic electrophiles and organoboron derivatives to form new carbon-carbon bonds is known as Suzuki-type cross-coupling reaction (Miyaura, N.; Suzuki, A., Chem. Rev., 95, pages 2457 to 2483 (1995)).

The organoboron compounds required for the Suzuki-type cross-coupling reaction can be accessed in numerous ways, a common method is e.g. the reaction of an diboron derivative like bis(pinacolato)diboron with an aryl halide in the presence of a Palladium catalyst (T. Ishiyama et al., J. Org. Chem., 60, pages 7508 to 7510 (1995)). Although bis(pinacolato)diboron is commercially available it is still a rather expensive compound.

Molander et al. disclosed a method of producing arylboronic acid esters starting from tetrahydroxydiboron (B2(OH)₄) in ethanol via a two-step process (G. A. Molander et al., J. Am. Chem. Soc., 132, pages 17701 to 17703 (2010)). A boronic acid ethyl ester was postulated as intermediate, that could not be isolated but transferred in a further reaction step to the corresponding cyclic boronic acid esters or trifluoroborates, which are more stable. Molander's protocol does not work with aryl bromides, requires a rather expensive catalyst and to work at low concentration (0.1 M) seems to be essential, which all together does not favour its industrial application. Even the formation of the boronic acid ethyl ester is not a one-step process according to the Supporting Information available to Molander's paper at http://pubs.acs.org.

U.S. Pat. No. 6,794,529 disclosed the application of tetrahydroxydiboron or tetrakis(dimethylamino)diboron for the catalytic reaction with aryl bromides in methanol followed by reaction with a second aryl halide to form the cross-coupled product. An intermediate has neither been characterized nor isolated.

The development of an improved process for the production of cyclic organoboronic acid esters, that can be carried out on a commercial scale and avoids the application of expensive reagents, is highly desirable.

### SUMMARY OF THE INVENTION

Therefore, it was an object of the present invention to provide a simple and efficient process for the production of cyclic organoboronic acid esters. The new process should preferably give access to cyclic aryl- and heteroarylboronic acid esters.

Accordingly, a novel process for the preparation of cyclic organoboronic acid esters has been found, comprising the step of reacting an organohalide with a diol and tetrahydroxydiboron or tetrakis(dimethylamino)diboron in the presence of a transition metal catalyst and a base.

### DETAILED DESCRIPTION OF THE INVENTION

According to the invention the process for the preparation of cyclic organoboronic acid esters comprises the step of reacting an organohalide with a diol and tetrahydroxydiboron or tetrakis(dimethylamino)diboron in the presence of a transition metal catalyst and a base.

In one embodiment of the present invention the process is carried out without a solvent. In a preferred embodiment of the present invention the process is carried out in a solvent. Suitable solvents are, for example, aliphatic or aromatic hydrocarbons, ethers, water and mixtures thereof. Examples of suitable solvents are toluene, pentane, hexane, heptane, diethylether, tetrahydrofuran (THF), methyl-tert.-butylether and water.

As used in connection with the present invention, the term “organohalide” denotes an organic compound in which an alkyl, cycloalkyl, substituted alkyl, alkenyl, cycloalkenyl, alkynyl, aryl or heteroaryl group is directly bound to a halide. Preferred organohalides are alkyl, alkenyl, allyl, aryl and heteroaryl halides. Even more preferred are aryl and heteroaryl halides.

The term “halide” denotes a halide atom like chlorine, bromine or iodine, or halide-like groups like trifluoromethanesulfonate (triflate), methanesulfonate (mesylate) or p-toluenesulfonate (tosylate). Preferred halides are bromine, iodine and triflate. Even more preferred halides are bromine and iodine.

The term “aryl” denotes an unsaturated hydrocarbon group comprising between 6 and 14 carbon atoms including at least one aromatic ring system like phenyl or naphthyl or any other aromatic ring system. Further, one or more of the hydrogen atoms in said unsaturated hydrocarbon group may be replaced by a halogen atom or an organic group comprising at least one carbon atom, that may contain heteroatoms like hydrogen, oxygen, nitrogen, sulphur, phosphorus, fluorine, chlorine, bromine, iodine, boron, silicon, selenium, tin or transition metals like iron, nickel, zinc, platinum, etc. The organic group can have any linear or cyclic, branched or unbranched, mono- or polycyclic, carbo- or heterocyclic, saturated or unsaturated molecular structure and may comprise protected or unprotected functional groups like nitrile, aldehyde, ester, alkoxy, nitro, carbonyl and carboxylic acid groups, etc. Furthermore, the organic group may be linked to or part of an oligomer or polymer with a molecular weight up to one million Dalton. Preferred organic groups are alkyl, cycloalkyl, substituted alkyl, alkenyl, cycloalkenyl, alkynyl, aryl and heteroaryl groups. Examples of aryl groups are phenyl, toluoyl, xylyl, naphthyl and anisyl.

The term “heteroaryl” denotes a mono- or polycyclic aromatic ring system comprising between 3 and 14 ring atoms, in which at least one of the ring carbon atoms is replaced by a heteroatom like nitrogen, oxygen, sulphur or phosphorus. Further, one or more of the hydrogen atoms in said mono- or polycyclic aromatic ring system may be replaced by a halogen atom or an organic group comprising at least one carbon atom, that may contain heteroatoms like hydrogen, oxygen, nitrogen, sulphur, phosphorus, fluorine, chlorine, bromine, iodine, boron, silicon, selenium, tin or transition metals like iron, nickel, zinc, platinum, etc. The organic group can have any linear or cyclic, branched or unbranched, mono- or polycyclic, carbo- or heterocyclic, saturated or unsaturated molecular structure and may comprise protected or unprotected functional groups like nitrile, aldehyde, ester, alkoxy, nitro, carbonyl and carboxylic acid groups, etc. Furthermore, the organic group may be linked to or part of an oligomer or polymer with a molecular weight up to one million Dalton. Preferred organic groups are alkyl, cycloalkyl, substituted alkyl, alkenyl, cycloalkenyl, alkynyl, aryl and heteroaryl groups.

Examples of heteroaryl groups are pyridyl, pyranyl, thiopyranyl, chinolinyl, isochinolinyl, acridyl, pyridazinyl, pyrimidyl, pyrazinyl, phenazinyl, triazinyl, pyrrolyl, furanyl, thiophenyl, indolyl, isoindolyl, pyrazolyl, imidazolyl, oxazolyl, isoxazolyl, thiazolyl, isothiazolyl and triazolyl.

As used in connection with the present invention, the term “alkyl” denotes a branched or an unbranched saturated hydrocarbon group comprising between 1 and 24 carbon atoms; examples are methyl, ethyl, propyl, isopropyl, butyl, isobutyl, sec-butyl, tert-butyl, amyl, isoamyl, sec-amyl, 1,2-dimethylpropyl, 1,1-dimethylpropyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1-2-pentylheptyl and isopinocampheyl. Preferred are the alkyl groups methyl, ethyl, propyl, isopropyl, butyl, isobutyl, sec-butyl, tert-butyl, amyl, isoamyl, sec-amyl, 1,2-dimethylpropyl, 1,1-dimethylpropyl, hexyl and octyl.

The term “cycloalkyl” denotes a saturated hydrocarbon group comprising between 3 and 16 carbon atoms including a mono- or polycyclic structural moiety. Examples are cyclopropyl, cyclobutyl, cyclopentyl, cyclohexyl, cycloheptyl, cyclooctyl, cyclononyl or cyclodecyl. Preferred are the cycloalkyl groups cyclopropyl, cyclopentyl and cyclohexyl.

The term “substituted alkyl” denotes an alkyl group in which at least one hydrogen atom is replaced by a halide atom like fluorine, chlorine, bromine or iodine, an alkoxy group, an ester, nitrile, aldehyde, carbonyl or carboxylic acid group, a trimethylsilyl group, an aryl group, or a heteroaryl group.

The term “alkoxy” stands for a group derived from an aliphatic monoalcohol with between 1 and 20 carbon atoms.

The term “alkenyl” denotes a straight chain or branched unsaturated hydrocarbon group comprising between 2 and 22 carbon atoms including at least one carbon-carbon double bond. Examples are vinyl, allyl, 1-methylvinyl, butenyl, isobutenyl, 3-methyl-2-butenyl, 1-pentenyl, 1-hexenyl, 3-hexenyl, 2,5-dimethylhex-4-en-3-yl, 1-heptenyl, 3-heptenyl, 1-octenyl, 1-nonenyl, 2-nonenyl, 3-nonenyl, 1-decenyl, 3-decenyl, 1,3-butadienyl, 1-4-pentadienyl, 1,3-hexadienyl and 1,4-hexadienyl. Preferred are the alkenyl groups vinyl, allyl, butenyl, isobutenyl, 1,3-butadienyl and 2,5-dimethylhex-4-en-3-yl.

The term “cycloalkenyl” denotes an unsaturated hydrocarbon group comprising between 5 and 15 carbon atoms including at least one carbon-carbon double bond and a mono- or polycyclic structural moiety. Examples are cyclopentenyl, 1-methylcyclopentenyl, cyclohexenyl, cyclooctenyl, 1,3-cyclopentadienyl, 1,3-cyclohexadienyl, 1,4-cyclohexadienyl, 1,3-cycloheptadienyl, 1,3,5-cycloheptatrienyl and 1,3,5,7-cyclooctatetraenyl.

The term “alkynyl” denotes a straight chain or branched unsaturated hydrocarbon group comprising between 2 and 22 carbon atoms including at least one carbon-carbon triple bond. Examples of alkynyl groups include ethynyl, 2-propynyl and 2- or 3-butynyl.

As used in connection with the present invention, the term “diol” denotes an organic compound in which two hydroxyl groups are linked to two different carbon atoms. Preferably the two hydroxyl groups are linked to two adjacent carbon atoms (giving vicinal diols) or to two carbon atoms which are separated by one further atom (giving e.g. 1,3-diols). Examples of diols are ethylene glykol, 1,2-propanediol, 1,3-propanediol, 1,3-butanediol, 2-methyl-2,4-pentanediol, pinacol and neopentyl glycol. Preferred are pinacol and neopentyl glycol.

The process of the present invention has to be carried out in the presence of a base. As used in connection with the present invention, the term “base” denotes any type of compound which gives an alkaline reaction in water and which is able to catalyse a borylation reaction. Examples are potassium acetate, potassium phosphate, potassium carbonate, sodium or lithium analogues of these potassium salts, trimethylamine and triethylamine.

The process of the present invention has to be carried out in the presence of a transition metal catalyst. As used in connection with the present invention, the term “transition metal catalyst” denotes a transition metal complex suitable to catalyse a borylation reaction. Preferred transition metal catalysts comprise a Group 8 metal of the Periodic Table, e.g. Ni, Pt, Pd or Co. In another preferred embodiment of the present invention the transition metal catalyst comprises one or more phosphine ligands which are complexing the transition metal. Even more preferred are Pd or Co compounds like PdCl₂, CoCl₂ and Pd(OAc)₂. Most preferred are palladium phosphine complexes like Pd(PPh₃)₄, PdCl₂(dppf), and related palladium catalysts which are complexes of phosphine ligands like P(i-Pr)₃, P(cyclohexyl)₃, 2-dicyclohexylphosphino-2′,4′,6′-triisopropylbiphenyl (X-Phos), 2-dicyclohexylphosphino-2′,6′-dimethoxybiphenyl (S-Phos), (2,2″-bis(diphenylphosphino)-1,1″-binaphthyl) (BINAP) or Ph₂P(CH₂)ₙPPh₂ with n is 2 to 5.

The process of the present invention is usually carried out at temperatures between room temperature and 100° C., preferably at temperatures between 60 and 90° C.

In one embodiment of the present invention the diol is reacted with the base and the tetrahydroxydiboron or tetrakis(dimethylamino)diboron before addition of the organohalide and the transition metal catalyst. In another embodiment of the present invention all components are combined before the entire mixture is heated to the desired reaction temperature.

In one embodiment of the present invention approximately two equivalents of diol are employed relative to one equivalent of tetrahydroxydiboron or tetrakis(dimethylamino)diboron. In another embodiment of the present invention at least one equivalent of tetrahydroxydiboron or tetrakis(dimethylamino)diboron is employed relative to the organohalide. In a preferred embodinvent of the present invention the molar ratio between tetrahydroxydiboron or tetrakis(dimethylamino)diboron and the organohalide is in the range of from 1.1 to 2, even more preferred in the range of from 1.2 to 1.5.

Products of the process according to the invention are cyclic organoboronic acid esters. For example, if 4-bromoacetophenone is used as aryl halide and pinacol as diol the product is 4-(4,4,5,5-tetramethyl-1,3,2-dioxaborinan-2-yl)acetophenone (cf. Example 1). These products can be isolated or without isolation subject to a further reaction like a Suzuki coupling reaction.

Another embodiment of the present invention is therefore a process for cross-coupling of two organohalides, comprising the preparation of an organoboronic acid ester according to the process described above followed directly by the addition of a second organohalide.

### EXAMPLES

All reactions have been analyzed by gas chromatography (GC) using an Agilent 5890 S gas chromatograph with an FID detector and a RT-1 column, 30 m×0.53 mm, 1.5 μm.

### Example 1

Borylation with Tetrahydroxydiboron (B2(OH)₄)

### 4 eq of Diol and 2 eq of B2(OH)₄; Table 1

Potassium acetate (KOAc) (7.36 g, 75.0 mmol, 3 eq), pinacol (11.8 g, 100 mmol, 4 eq) and B2(OH)-4 (4.48 g, 50.0 mmol, 2 eq) were suspended in toluene (210 ml). The reaction mixture was heated for 2 h to 80° C. before a solution of 4-bromoacetophenone (4.98 g, 25.0 mmol) and [1,1″-Bis(diphenylphosphino)ferrocene]dichloropalladium(II) (Pd(dppf)₂Cl₂) (1.02 g, 1.25 mmol, 5 mol %) in toluene (10 ml) was added. The reaction mixture was stirred for 22 h at 80° C. The progress of the reaction was monitored by GC (see #1 in Table 1). The resulting product has been confirmed by GC-MS analysis.

Retention time: Starting material: 12.88 min; Product: 18.202 min.

Table 1 shows that neopentyl glycol can be used as diol (#2) as well.

Retention time Starting material: 12.88 min; Product: 19.28 min.

TABLE 1
Borylation with B₂(OH)₄

| | | | | | Borylation | |
|---|---|---|---|---|---|---|
| | | | | Temp. | Time | Completion |
| # | DIOL | Cat. | Solvent | [° C.] | [h] | [GC-%] |
| 1 | Pinacol | PdCl₂(dppf) | Toluene | 80 | 18 | 100 |
| | | (5 mol-%) | | | | |
| 2 | Neopentyl | PdCl₂(dppf) | | | 4.5 | 100 |
| | glycol | (5 mol-%) | | | 21 | 100 |

### Example 2

### Borylation with B2(OH)₄

### 2.4 eq of Diol and 1.2 eq of B2(OH)₄

KOAc (1.84 g, 18.7 mmol, 3 eq), neopentyl glycol (1.56 g, 15.0 mmol, 2.4 eq) and B2(OH)₄ (672 mg, 7.50 mmol, 1.2 eq) were suspended in toluene (25 ml) or THF (25 ml). The reaction mixture was stirred at 80° C. for 2 h before a solution of 4-bromoacetophenone (1.24 g, 6.25 mmol) and Pd-catalyst [either PdCl₂(dppf) or Pd(PPh₃)₄; 2 or 5 mol-%; see table 2] in toluene (5 ml) or THF (5 ml) was added. The resulting reaction mixture was stirred for 22 h at 80° C. The reaction was monitored by GC. The product was identified by its mass using GC-MS-technology.

TABLE 2
Borylation with B₂(OH)₄ (1.2 eq) and Neopentylglycol (2.4 eq)

| | | | | Borylation | |
|---|---|---|---|---|---|
| | | | Temp. | Time | Completion |
| # | Catalyst | Solvent | [° C.] | [h] | [GC-%] |
| 1 | PdCl₂(dppf) (255 mg, | Toluene | 80 | 3 | 44.2 |
| | 0.312 mmol, 5 mol-%) | | | 22 | 99.8 |
| 2 | PdCl₂(dppf) (102 mg, | | | 3 | 91.2 |
| | 0.125 mmol, 2 mol-%) | | | 22 | 99.9 |
| 3 | Pd(PPh₃)₄ (144 mg, | | | 3 | 22.8 |
| | 0.125 mmol, 2 mol-%) | | | 22 | 96.7 |
| 4 | PdCl₂(dppf) (102 mg, | THF | | 3 | 99.6 |
| | 0.125 mmol, 2 mol-%) | | | 22 | 99.9 |

### Example 3

### Borylation with tetrakis(dimethylamino)diboron (tetrakis)

### Variation of Solvent (Table 3)

This example points out that a broad variety of solvents can be used for the borylation reaction.

KOAc (1.84 g, 18.7 mmol, 3 eq), neopentyl glycol (1.56 g, 15.0 mmol, 2.4 eq) and tetrakis (1.48 mg, 7.50 mmol, 1.2 eq) were suspended in the corresponding solvent (see Table 3, 25 ml). The reaction mixture was heated for 30 min to 80° C., before a solution of 4-bromoacetophenone (1.24 g, 6.25 mmol) and the corresponding Pd-catalyst (see Table 3; 2 mol-%) in the corresponding solvent (5 ml) was added. The resulting reaction mixture was stirred for 22 h at 80° C. The reaction mixture was examined by GC.

TABLE 3
Variation of solvent and catalyst

| | | | Borylation | |
|---|---|---|---|---|
| | | | Time | Completion |
| # | Catalyst | Solvent | [h] | [GC-%] |
| 1 | PdCl₂(dppf) (102 mg, | toluene | 3 | 25.8 |
| | 0.125 mmol, 2 mol-%) | | 22 | 91.5 |
| 2 | Pd(PPh₃)₄ (144 mg, | | 3 | 48.5 |
| | 0.125 mmol, 2 mol-%) | | 22 | 99.9 |
| 3 | | THF | 3 | 38.6 |
| | | | 22 | 99.7 |
| 5 | | heptane | 3 | 32.4 |
| | | | 22 | 99.9 |
| 6 | | THF, H₂O | 3 | 23.8 |
| | | (0.011 g, 0.625 | 22 | 95.9 |
| | | mmol, 0.1 eq) | | |

### Example 4

### Borylation with tetrakis catalyzed by PdCl₂/PPh₃

KOAc (1.84 g, 18.7 mmol, 3 eq), neopentyl glycol (1.56 g, 15.0 mmol, 2.4 eq) and tetrakis (1.48 mg, 7.50 mmol, 1.2 eq) were suspended in toluene (25 ml). The reaction mixture was heated for 30 min to 80° C. PdCl₂ (22.2 mg, 0.125 mmol, 2 mol-%) and PPh₃ (163 mg, 0.50 mmol, 8 mol %) in toluene (5 ml) were stirred for 30 min before 4-bromoacetophenone (1.24 g, 6.25 mmol) was added. Then the catalyst solution was added to the borylation mixture. The resulting reaction mixture was stirred for 22 h at 80° C.

The GC-chromatogram of the reaction mixture showed 51.7% conversion to the product after 3 h and 99.7% after 22 h. The product was confirmed by its mass using GC-MS-technology.

### Example 5

### Borylation with Tetrakis

### Variation of Diol (Table 4)

This example shows that a wide range of different diols can be used for the in-situ borylation.

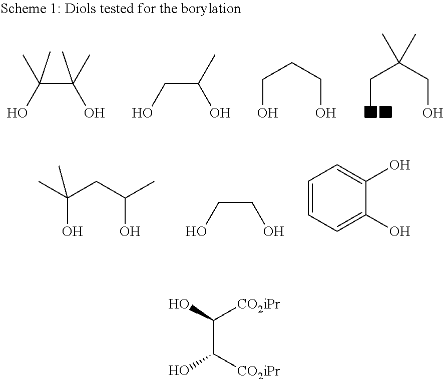

KOAc (1.84 g, 18.7 mmol, 3 eq), the corresponding diol (Table 4; 15.0 mmol, 2.4 eq) and tetrakis (1.48 mg, 7.50 mmol, 1.2 eq) were suspended in toluene (25 ml). The reaction mixture was stirred for 2 h to 80° C. before a solution of 4-bromoacetophenone (1.24 g, 6.25 mmol) and Pd(PPh₃)₄ (144 mg, 0.125 mmol, 2 mol-%) in toluene (5 ml) was added. The resulting reaction mixture was stirred for 22 h at 80° C. The progress of the reaction was examined by GC. The product was identified by its mass using GC-MS-technology.

TABLE 4
Variation of diol

Borylation

| | | | Completion |
|---|---|---|---|
| # | DIOL | Time [h] | [GC-%] |
| 1 | Neopentyl glycol | 3 | 48.5 |
| | (1.56 g) | 22 | 99.9 |
| 2 | Ethyleneglycol | 3 | 34.9 |
| | (931 mg) | 22 | 38.5 |
| 3^{b)} | Catechol | 3 | 0 |
| | (1.65 g) | 22 | 0 |
| 4 | 1,3-propanediol | 3 | 20.2 |
| | (1.14 g) | 22 | 90.8 |
| 5 | 1,3-butanediol | 3 | 15.3 |
| | (1.35 g) | 22 | 90.3 |
| 6 | 1,2-propanediol | 3 | 76.9 |
| | (1.14 g) | 22 | 91.7 |
| 7 | hexylene glycol | 3 | 6.2 |
| | (1.77 g) | 22 | 18.8 |
| 8^{a)} | hexylene glycol | 3 | 30.2 |
| | (1.77 g) | 24 | 87.3 |
| 9^{b)} | (+)-diisopropyl-L-tartrate | 3 | 0 |
| | (3.51 g) | 22 | 0 |

^{a)}PdCl₂(dppf) (102 mg, 0.125 mmol, 2 mol-%) was used.
^{b)}Comparative example

### Example 6

### Borylation with Tetrakis

### All at once Borylation

This example highlights that the described method also is successful when all reagents are present from the beginning on.

All reagents, KOAc (1.84 g, 18.8 mmol, 3 eq), tetrakis (1.48 g, 6.25 mmol, 1.2 eq), Pd(PPh₃)₄ (144 mg, 0.125 mmol, 2 mol-%) and 4-bromoacetophenone (1.24 g, 6.25 mmol) and neopentyl glycol (1.56 g, 15.0 mmol, 2.4 eq) were suspended in toluene (25 ml). The reaction mixture was heated to 80° C. and stirred for 24 h. The progress of the reaction was monitored by GC (Table 5). The final product was confirmed by its mass using GC-MS-technology.

TABLE 5
Borylation with all the reagents from the beginning^{a)}

Borylation

| # | Time [h] | Completion [GC-%] |
|---|---|---|
| 1 | 1 | 24.9 |
| 2 | 2 | 45.8 |
| 3 | 3 | 62.2 |
| 4 | 5 | 73.7 |
| 5 | 24 | 99.9 |

^{a)}with only 1 mol-% of Pd(PPh₃)₄ the reaction is slower (conversion after 22 h: 67.5%).

### Example 7

### Borylation with Tetrakis

### Borylation without Solvent

7.1 1,3-propanediol

All reagents, KOAc (22.97 g, 0.234 mol, 3 eq), tetrakis (18.5 g, 0.094 mol, 1.2 eq), Pd(PPh₃)₄ (1.8 g, 1.56 mmol, 2 mol-%) and 4-bromoacetophenone (15.5 g, 78.0 mmol), were suspended in 1,3-propanediol (15 ml, 14.2 g, 0.187 mol, 2.4 eq). The reaction mixture was stirred at 80° C. for 22 h. The progress of the reaction was monitored by GC. After 3 h the GC showed 26.1% cornpletion, after 22 h 84.8%. The final product was identified by its mass using GC-MS-technology.

7.2 Hexylene glycol

All reagents, KOAc (4.8 g, 48.9 mmol, 3 eq), tetrakis (3.87 g, 19.6 mmol, 1.2 eq), PdCl₂(dppf) (266 mg, 0.326 mmol, 2 mol-%) and 4-bromoacetophenone (3.25 g, 16.3 mmol), were suspended in hexylene glycol (5 ml, 4.65 g, 39.1 mmol, 2.4 eq). The reaction mixture was stirred at 80° C. for 24 h. The progress of the reaction was monitored by GC. After 1 h the GC showed 17.1% completion and after 24 h 99.97%. The final product was confirmed by its mass using GC-MS-technology.

### 7.3 1,2-Propanediol

All reagents, KOAc (8.35 g, 85.2 mmol, 3 eq), tetrakis (3.87 g, 34.1 mmol, 1.2 eq), Pd(PPh₃)₄ (0.66 g, 0.57 mmol, 2 mol-%) and 4-bromoacetophenone (5.65 g, 28.4 mmol), were suspended in 1,2-propanediol (5 ml, 5.18 g, 68.2 mmol, 2.4 eq). The reaction mixture was stirred at 80° C. for 24 h. The progress of the reaction was monitored by GC. After 1 h the GC showed 99.3% completion, after 3 h 99.7% and finally after 22 h 100%. The final product was confirmed by its mass using GC-MS-technology.

### Example 8

### Borylation with Tetrakis

### Variation of Base (Table 6)

Base (type of base and amounts see Table 6), neopentyl glycol (1.56 g, 15.0 mmol, 2.4 eq) and Tetrakis (1.48 mg, 7.50 mmol, 1.2 eq) were suspended in toluene (25 ml). The reaction mixture was heated for 30 min at 80° C., before a solution of 4-bromoacetophenone (1.24 g, 6.25 mmol) and Pd(PPh₃)₄ (144 mg, 0.125 mmol, 2 mol-%) in toluene (5 ml) was added. The resulting reaction mixture was stirred for 22 h at 80° C. The conversion of the reaction was followed by GC. The final product was identified by its mass using GC-MS-technology.

TABLE 6
Variation of base and amount of base

Borylation

| | | Time | Completion |
|---|---|---|---|
| # | Base | [h] | [GC-%] |
| 1 | No base | 3 | 2.7 |
| | | 22 | 4.7 |
| 2 | KOAc | 3 | 19.9 |
| | (920 mg, 9.38 mmol, 1.5 eq) | 22 | 75.9 |
| 3 | KOAc | 3 | 37.6 |
| | (1.23 g, 12.5 mmol, 2 eq) | 22 | 99.7 |
| 4 | K₃PO₄ | 3 | 22 |
| | (3.98 g, 18.8 mmol, 3 eq) | 22 | 65 |
| 5 | NEt₃ | 3 | 2.3 |
| | (1.9 g, 18.8 mmol, 3 eq) | 22 | 9.98 |
| 6 | KTB | 3 | Not anal. |
| | (2.1 g, 18.8 mmol, 3 eq) | 22 | 0 |
| 7 | K₂CO₃ | 3 | 3.97 |
| | (2.59 g, 18.8 mmol, 3 eq) | 22 | 11.3 |

### Example 9

### Borylation with Tetrakis

### Borylation of Aryl Bromides (Table 7)

KOAc (1.84 g, 18.6 mmol, 3.0 eq.), neopentyl glycol (1.56 g, 15.0 mmol, 2.4 eq.) and tetrakis (1.48 g, 7.50 mmol, 1.2 eq.) were suspended in toluene (25 ml) and heated to 80° C. for 30 min. Afterwards a solution of the corresponding aryl bromide (see Table 7) and Pd-catalyst [Pd(PPh₃)₄ (144 mg, 0.125 mmol, 2 mol-%) or PdCl₂(dppf) (102 mg, 0.125 mmol, 2 mol-%)] in toluene (5 ml) was added at 80° C. The conversion of the reaction was followed by GC. The final product was identified by its mass using GC-MS-technology.

TABLE 7
Examples of the borylation with tetrakis/neopentyl glycol

| | | | Borylation | |
|---|---|---|---|---|
| | | | Time | Conversion |
| # | Ar—Br | CATALYST | [h] | [GC-%] |
| 1 | 1-Bromo-4-tbutyl benzene | Pd(PPh₃)₄ | 3 | 15.9 |
| | | | 22 | 77.3 |
| | 1-Bromo-4-tbutyl benzene | PdCl₂(dppf) | 3 | 4.4 |
| | | | 22 | 99.6 |
| 2 | 4-Bromo-benzotrifluoride | Pd(PPh₃)₄ | 3 | 21.8 |
| | | | 22 | 85.6 |
| | 4-Bromo-benzotrifluoride | PdCl₂(dppf) | 3 | 100 |
| | | | 22 | 100 |
| 3 | 4-Bromo-anisole | Pd(PPh₃)₄ | 3 | 35.1 |
| | | | 22 | 96.6 |
| 4 | Ethyl-4 bromobenzoate | Pd(PPh₃)₄ | 3 | 16.8 |
| | | | 22 | 99.6 |
| 5 | 2-Bromo-anisole | Pd(PPh₃)₄ | 3 | 9.8 |
| | | | 22 | 81.7 |
| 6 | 3-Bromo-anisole | PdCl₂(dppf) | 3 | 51.4 |
| | | | 22 | 100 |
| 7 | 4-Bromo-N,N-dimethyl-aniline | PdCl₂(dppf) | 3 | 97.4 |
| | | | 22 | 100 |
| 8 | 4-Bromo-2-methyl pyridine | PdCl₂(dppf) | 3 | 59.6 |
| | | | 22 | 99.8 |
| 9 | 1-Bromo-4-fluorobenzene | PdCl₂(dppf) | 3 | 58 |
| | | | 22 | 99.3 |
| 10 | 1-Bromo-3,4,5-trifluorobenzene | PdCl₂(dppf) | 3 | 45.1 |
| | | | 22 | 99.1 |

TABLE 8
Retention times of aryl bromides and their borylation products

| # | Arylbromide | Retention time [min] | |
|---|---|---|---|
| 1 | 1-Bromo-4-tbutyl benzene | Starting Material | 12.433 |
| | | Product | 18.646 |
| 2 | 4-Bromo-benzotrifluoride | Starting Material | 7.154 |
| | | Product | 14.502 |
| 3 | 4-Bromo-anisole | Starting Material | 11.247 |
| | | Product | 17.613 |
| 4 | Ethyl-4-bromobenzoate | Starting Material | 14.351 |
| | | Product | 20.975 |
| 5 | 2-Bromo-anisole | Starting Material | 11.262 |
| | | Product | 16.855 |
| 6 | 3-Bromo-anisole | Starting Material | 11.513 |
| | | Product | 17.791 |
| 7 | 4-Bromo-N,N-dimethylaniline | Starting Material | 14.355 |
| | | Product | 20.321 |
| 8 | 4-Bromo-2-methyl pyridine | Starting Material | 8.740 |
| | | Product | 16.299 |
| 9 | 1-Bromo-4-fluorobenzene | Starting Material | 6.933 |
| | | Product | 14.405 |
| 10 | 1-Bromo-3,4,5- | Starting Material | 6.197 |
| | trifluorobenzene | Product | 14.316 |

### Example 10

### Borylation with Tetrakis

### Aryl Chlorides

KOAc (1.84 g, 18.8 mmol, 3.0 eq.), neopentyl glycol (1.56 g, 15.0 mmol, 2.4 eq.) and tetrakis (1.48 g, 7.50 mmol, 1.2 eq.) were suspended in toluene (25 ml) and heated to 80° C. for 30 min. Afterwards a solution of the corresponding aryl chloride (see Table 9) and Pd-catalyst (see Table 9) in toluene (5 ml) was added and stirred at 80° C. for 22 h. The conversion of the reaction was followed by GC. The final product was identified by its mass using GC-MS-technology.

TABLE 9
Borylation of arylchlorides^{a)}

| | | | Borylation | |
|---|---|---|---|---|
| | | | Time | Conversion |
| # | Catalyst | ArCl | [h] | [GC-%] |
| 1^{a)} | Pd(OAC)₂ | 4-chloro | 3 | 44.5 |
| | (28.1 mg, 0.125 | acetophenone | 22 | 94.1 |
| | mmol, 2 mol-%) | (0.97 g, | | |
| | X-Phos | 6.25 mmol) | | |
| | (119 mg, 0.25 | | | |
| | mmol, 4 mol-%) | | | |
| 2 | PdCl₂(dppf) (102 | Methyl 4-chloro- | 3 | 25.4 |
| | mg, 0.125 mmol, | benzoate (1.07 | 22 | 60.9 |
| | 2 mol-%) | g, 6.25 mmol) | | |

^{a)}other Pd-catalysts (2 mol-%) gave lower yields: Pd(PPh₃)₄: 18.1% after 22 h; PdCl₂(dppf): 55.3%. - after 22 h.

TABLE 10
Retention times of aryl chlorides and their borylation products

| | | |
|---|---|---|
| # | Aryl chloride | Retention time [min] |

| | | | |
|---|---|---|---|
| 1 | 4-Chloro-acteophenone | Starting Material | 11.576 |
| | | Product | 19.314 |
| 2 | Methyl 4-chloro-benzoate | Starting Material | 12.044 |
| | | Product | 19.725 |

### Example 11

### In-Situ Borylation and Suzuki-Coupling

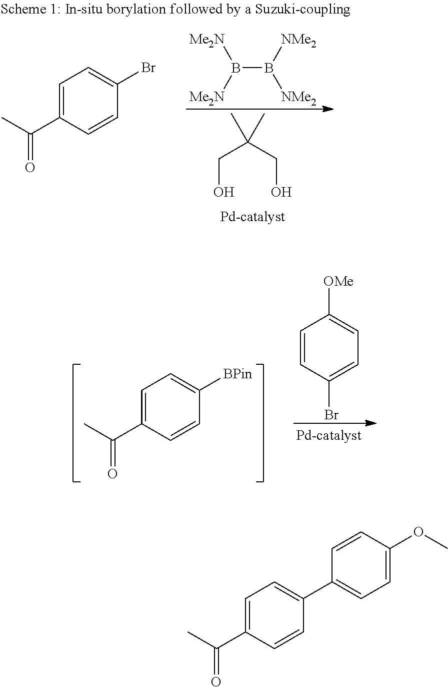

KOAc (1.84 g, 18.8 mmol, 3 eq), tetrakis (1.48 g, 7.50 mmol, 1.2 eq) and neopentyl glycol (1.56 g, 15.0 mmol, 2.4 eq) were suspended in THF (25 ml) and heated to 80° C. for 30 min. Afterwards, PdCl₂(dppf) (102 mg, 0.125 mmol, 2 mol-%) and 4-bromoacetophenone (1.24 g, 6.25 mmol) in THF (5 ml) was added. The reaction mixture was stirred at 80° C. for 24 h. After the completion of the borylation, H₂O (3.12 ml) was added. Then a solution of 4-bromo anisole (1.17 g, 6.25 mmol, 1.0 eq) and PdCl₂(dppf) (102 mg, 0.125 mmol, 2 mol-%) was added. The reaction was stirred at 80° C. The progress of the reaction was monitored by GC. After 22 h, 42.7% Suzuki couplings product was detected and confirmed by its mass using GC-MS-technology.

### Retention Time:

starting material: 4-bromoacetophenone: 12.86 min; 4-bromo anisole 11.2 min;
borylation product: 19.34 min; Suzuki coupling product: 23.19 min.

### Example 12

### In-Situ Borylation of Vinyl-Halides

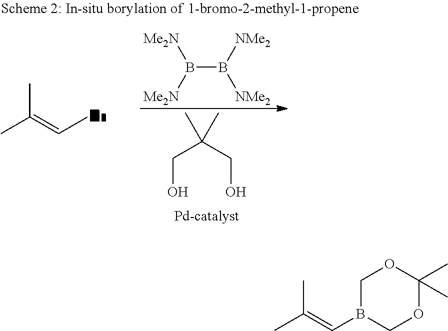

KOAc (1.84 g, 18.8 mmol, 3 eq), tetrakis (1.48 g, 7.50 mmol, 1.2 eq) and neopentyl glycol (1.56 g, 15.0 mmol, 2.4 eq) were suspended in THF (25 ml) and heated to 80° C. for 30 min. Afterwards, Pd(PPh₃)₄ (140 mg, 0.125 mmol, 2 mol-%) and 1-bromo-2-methyl-1-propene (843 mg, 6.25 mmol) in THF (5 ml) was added. The reaction mixture was stirred at 80° C. for 24 h. After 24 h, the GC showed 100% conversion to the borylation product, which was confirmed by its mass using GC-MS-technology.

Using PdCl₂(PPh₃)₂ (3 mol-%) and PPh₃ (6 mol-%) also resulted in 100% conversion after 24 h.

### Retention Time:

starting material: 1-bromo-2-methyl-1-propene: 3.33 min; borylation product: 10.37 min

### Example 13

### In-Situ Borylation of a Vinyltriflate and Phenyltriflate

TABLE 11
Examples of the borylation of a vinyltriflate and phenyltriflate

| | | | Borylation | |
|---|---|---|---|---|
| | | | Time | Conversion |
| # | Ar—Br | CATALYST | [h] | [GC-%] |
| 1 | 1-Cyclohexenyl | PdCl₂(PPh₃)₂ + | 3 | 100 |
| | trifluoromethanesulfonate | 2 PPh₃ | 24 | 100 |
| 2 | Phenyl trifluoromethane- | | 3 | 40.2 |
| | sulfonate | | 22 | 98.4 |

KOAc (1.84 g, 18.8 mmol, 3 eq), tetrakis (1.48 g, 7.50 mmol, 1.2 eq) and neopentyl glycol (1.56 g, 15.0 mmol, 2.4 eq) were suspended in THF (25 ml) and heated to 80° C. for 30 min. Afterwards, PdCl₂(PPh₃)₂ (132 mg, 0.188 mmol, 3 mol-%) and PPh₃ (98.0 mg, 0.374 mmol, 6 mol-%) and triflate (see Table 11, 6.25 mmol) in THF (5 ml) was added. The reaction mixture was stirred at 80° C. for 24 h.

The borylation products were confirmed by their mass using GC-MS-technology.

### Retention Time:

TABLE 12
Retention times of starting materials and
products of the borylation of triflates

| # | R-OTf | Retention time [min] | |
|---|---|---|---|
| 1 | 1-Cyclohexenyl trifluoromethane- | Starting Material | 8.884 |
| | sulfonate | Product | 14.452 |
| 2 | Phenyl trifluoromethane- | Starting Material | 7.608 |
| | sulfonate | Product | 14.881 |

1-9. (canceled)

10. A process for the preparation of an organoboronic acid ester comprising the step of reacting an organohalide with a diol and tetrahydroxydiboron or tetrakis(dimethylamino)diboron in the presence of a transition metal catalyst and a base.

11. The process according to claim 10, wherein the diol is ethylene glycol, 1,2-propanediol, 1,3-propanediol, 1,3-butanediol, 2-methyl-2,4-pentanediol, pinacol or neopentyl glycol.

12. The process according to claim 10, wherein the base is potassium acetate, sodium acetate, lithium acetate, potassium phosphate, sodium phosphate, lithium phosphate, potassium carbonate, sodium carbonate, lithium carbonate, trimethylamine or triethylamine.

13. The process according to claim 10, wherein the transition metal catalyst comprises a Group 8 metal of the Periodic Table.

14. The process according to claim 10, wherein the transition metal catalyst comprises one or more phosphine ligands.

15. The process according to claim 10, wherein the transition metal catalyst is a palladium phosphine complex.

16. The process according to claim 10, wherein the organohalide is an aryl or heteroaryl halide.

17. The process according to claim 10, wherein all components are combined before the entire mixture is heated to the desired reaction temperature.

18. A process for cross-coupling of two organohalides, comprising the preparing the organoboronic acid ester according to claim 10 followed directly by the addition of a second organohalide.
